(19) United States
(12) Patent Application Publication
(10) Pub. No.: US 2011/0110208 A1
(43) Pub. Date: May 12, 2011

(54) COMA ABERRATION COMPENSATING DEVICE, COMA ABERRATION COMPENSATING METHOD, AND OPTICAL DISC

(75) Inventor: Takuma YANAGISAWA, Kawasaki (JP)

(73) Assignee: Pioneer Corporation, Kawasaki-shi (JP)

(21) Appl. No.: 13/006,945

(22) Filed: Jan. 14, 2011

Related U.S. Application Data
(63) Continuation of application No. PCT/JP2008/062757, filed on Jul. 15, 2008.

(51) Int. Cl. G11B 7/00

(52) U.S. Cl. 369/44.32; G9B/7

(57) ABSTRACT

A method for compensating the coma aberration in a pickup of a recording and reproducing device that records or reproduces data on or from an optical disc using the pickup is provided. The method includes a first coma aberration compensating step to compensate coma aberration in a body of an optical system including an objective lens for emitting a light beam to an optical disc including a plurality of recording layers and a second coma aberration compensating step to compensate coma aberration caused by relative inclination of the optical system with respect to the optical disc.

### TECHNICAL FIELD

The present invention relates to an optical disc including a plurality of recording layers stacked in turn, on or from each of which information is capable of be recorded or reproduced by using an irradiation of a light beam, and more particularly to a coma aberration compensating device for compensating coma aberration in a recording and reproducing device for such a optical disc and a method therefor.

### BACKGROUND ART

In recent years, an optical disc has been widely used as a recording medium on or from which data such as video data, audio data, or computer data is recorded or reproduced. For example, in Digital Versatile Disc (DVD) or Blu-ray disc (registered trademark) standards, a two layer disc having two recoding layers at one side thereof, from which reading is possible, has been practically used as a read-only or recordable disc.

Data recorded on both a shallow recording layer and a deep recording layer of the two layer disc can be read from one side of the optical disc simply by shifting the focal point of a light beam for reproduction to each layer. The shallow recording layer is formed of a semitransparent film and, the thickness and material of the shallow recording layer are selected such that a light beam is transmitted through the shallow recording layer to read an electrical signal of the deep recording layer. A reflective film is used as the deep recording layer. An optically transmissive spacer layer with a high transmittance at the wavelength of the light beam is provided between the shallow recording layer and deep recording layer in order to separate the two layers with a certain thickness.

Meanwhile, there is a demand for a next generation optical disc from or on which a much greater amount of data than the Blu-ray disc can be reproduced or recorded. A next generation multi-layer optical disc having a much greater number of recording layers has been suggested in order to meet such demand. In the recording technology of such a multi-layer optical disc, not only an attempt to optimize the thickness and material of each layer has been made to achieve a pertinent recording of the multi-layer optical disc as in the conventional two layer disc but also an attempt to reduce unnecessary optical absorption or scattering in portions other than focused by the beam spot using nonlinear optical effects such as two-photon absorption has been made in order to prevent attenuation of the light beam which would otherwise be caused by absorption and scattering of the light beam due to the intermediate recording layers.

In the recording technology of the multi-layer optical disc, there is a problem of aberration, especially coma aberration, caused by the inclination of the optical axis of the light beam with respect to the normal line to the recording layers, which is referred to as a “tilt”. This is because the coma aberration due to the tilt is proportional to a total of thicknesses of recording layers through which the light beam is transmitted until a target recording layer i.e., depth thereof, where such recording layers will be referred to as “transmitted layers” or “transmitted layer”. Therefore, when recording or reproduction is performed on a deep recording layer in the multi-layer optical disc, the greater the total thickness of the transmitted layers increases, the tilt exerts a greater influence on the coma aberration. To compensate the coma aberration is very important in the next generation multi-layer optical disc, because the coma aberration blurs the focal spot, reducing the recording or reproduction reliability.

An optical pickup device, which will also be referred to as a “pickup” or “PU” for short, in an optical disc recording and reproducing device generally includes an optical system including an objective lens, through which a light beam generated by a light source is incident on an optical disc. The pickup also includes an optical detector that photoelectrically converts light returned from the optical disc through the objective lens and outputs an electrical signal. Such a pickup has the following three types of coma aberrations.

(1) Coma aberration existing in an optical system of the pickup body caused by an assembly error or a processing error of optical parts of the optical system including an objective lens, which will also be referred to as “pickup-coma aberration” for short.

(2) Coma aberration caused when a light beam is incident on the optical disc in a direction inclined with respect to the optical axis (mainly to the optical axis of the objective lens), which will also be referred to as “off-axis coma aberration” for short.

(3) Coma aberration caused when the normal line to the optical disc substrate (or to the stack of recording layers) is inclined with respect to the optical axis (mainly to the optical axis of the objective lens), which will also be referred to as “transmitted-layer-coma aberration” since this is coma aberration associated with layers through which the light beam is transmitted until reaching a target recording layer.

Since it is difficult to completely eliminate the processing error or assembly error of the optical parts, the pickup-coma aberration (1) is generally canceled with the off-axis coma aberration (2) or by the transmitted-layer-coma aberration (3) at the stage of assembling the recording and reproducing device at the factory. Specific adjustment methods are described, for example, in Patent Literature 1 or Patent Literature 2.

In the adjustment method described in Patent Literature 1, a laser beam is focused on an information recording surface of a test optical disc and the shape of the focus spot is directly observed using a microscope and the mounting angle of an actuator is adjusted so as to minimize coma aberration.

In the adjustment method described in Patent Literature 2, in an optical disc recording and reproducing device that records or reproduces data on or from a plurality of types of information recording media such as CDs and DVDs, a plurality of laser beams is focused on an information recording surface of each of the information recording media and then, using reproduced signals (representing error rates) of the laser beams, the overall mounting angle of the pickup and the actuator is adjusted so as to minimize coma aberration.

In all the conventional methods, the aberration adjustment device is optimized so as to minimize the total amount of coma aberration (i.e., the sum of the amounts of coma aberrations (1) to (3)) of the entire optical system including the optical disc when the laser beam has been focused on the information recording surface after passing through the transmitted layers.

At the factory, coma aberration adjustment is generally performed using one of cancellation methods in which e.g., a first one, the entire body of the pickup is inclined to cancel the pickup-coma aberration with the transmitted-layer-coma aberration, a second cancellation method in which the objective lens is inclined to cancel the pickup-coma aberration with the off-axis-comatic and transmitted-layer-coma aberrations, or a third cancellation method in which the actuator is inclined to cancel the pickup-coma aberration with the off-axis-comatic and transmitted-layer-coma aberrations. That is, coma aberration adjustment is performed while monitoring coma aberration (or monitoring a signal associated with coma aberration or observing the coma aberration visually) after a beam is focused on the recording layer so that total coma aberration is minimized during recording or reproduction. In this case; there is a need to fix the total of thicknesses of the transmitted layers in the optical disc since at least the transmitted-layer-coma aberration is used to cancel the pickup-coma aberration. This is because the transmitted-layer-coma aberration is proportional to the total of thicknesses of the transmitted layers in the optical disc (in which such total of thicknesses of the transmitted layers will also be referred to as “transmitted layer's thickness” simply), a change of the transmitted layer's thickness in the optical disc will result in change of the transmitted-layer-coma aberration so that the transmitted-layer-coma aberration cannot be canceled with the pickup-coma aberration.

In addition, the aberration amount of the transmitted-layer-coma aberration is proportional to the transmitted layer's thickness in the optical disc and can be approximated by the following equation.

$$Coma ( T , θ ) ≡ \frac{1}{2 \sqrt{2}} \{ \frac{( {n}^{2} - 1 )}{6 {n}^{3}} \frac{{NA}^{3}}{λ} + \frac{( {n}^{2} + 3 ) ( {n}^{2} - 1 )}{20 {n}^{5}} \frac{{NA}^{5}}{λ} + \frac{( {n}^{4} + 2 {n}^{2} + 5 ) ( {n}^{2} - 1 )}{240 {n}^{7}} \frac{{NA}^{7}}{λ} \} \cdot T \cdot θ$$

In this equation, “NA” denotes the numerical aperture of the objective lens, “λ” denotes the wavelength for reproduction, “n” denotes the refractive index of the optical disc substrate, “T” denotes the transmitted layer's thickness in the optical disc, and “θ” denotes the angle of the pickup optical axis inclined from the normal line to the optical disc.

When recording or reproduction is performed on a multi-layer optical disc having a plurality of recording layers (i.e., having a transmitted layer's thickness) in an optical disc recording and reproducing device that has been adjusted using the conventional coma aberration adjustment (see Patent Literatures 1 and 2), the recording or reproduction characteristics of recording layers other than a specific recording layer, which is used as a reference during the adjustment, are degraded since the pickup-coma aberration is not canceled for the recording layers other than the specific recording layer.

For example, let us consider the case where NA=0.85, λ=405 nm, and n=1.6 and the pickup-coma aberration caused by processing or assembly errors of optical parts is 30 mλ. If the pickup body angle is adjusted with light being focused on a recording layer with a transmitted layer's thickness T=100 μm in a multi-layer optical disc, transmitted-layer-coma aberration is about 30 mλ when the inclination is at an angle of θ=0.34° and the transmitted-layer-coma aberration is exactly canceled with the pickup-coma aberration. In this state, there is obtained a total coma aberration (absolute value) when light is focused on a recording layer with a different transmitted layer's thickness T in the optical disk and it exhibits characteristics represented by a graph shown in FIG. 1.

Since it has been empirically shown that a sufficient system margin cannot be obtained unless the total coma aberration after adjustment is suppressed below about 15 mλ, reliable recording or reproduction is not performed on a recording layer with a depth of T≦50 μm or T≧150 μm. When Coma_{PU} (positive value) is the pickup-coma aberration caused by assembly errors, Comaₗᵢₘᵢₜ (positive value) is the upper limit of the total coma aberration after adjustment, and T₀ is a reference transmitted layer's thickness used in the optical disc when adjustment is performed, a range of transmitted layer's thicknesses T with which reliable recording or reproduction is possible can be generally obtained from the following inequalities.

$$\vert Coma ( T , {θ}_{0} ) - {Coma}_{PU} \vert \leq {Coma}_{Limit}$$

$${θ}_{0} = \frac{{Coma}_{PU}}{\frac{1}{2 \sqrt{2}} \{ \begin{matrix}\frac{( {n}^{2} - 1 )}{6 {n}^{3}} \frac{{NA}^{3}}{λ} + \frac{( {n}^{2} + 3 ) ( {n}^{2} - 1 )}{20 {n}^{5}} \frac{{NA}^{5}}{λ} + \\ \frac{( {n}^{4} + 2 {n}^{2} + 5 ) ( {n}^{2} - 1 )}{240 {n}^{7}} \frac{{NA}^{7}}{λ}\end{matrix} \} \cdot {T}_{0}}$$

This inequality can be rearranged into the following inequality.

$${T}_{0} ( 1 - \frac{{Coma}_{Limit}}{{Coma}_{PU}} ) \leq T \leq {T}_{0} ( 1 + \frac{{Coma}_{Limit}}{{Coma}_{PU}} )$$

The difference between the transmitted layer's thicknesses of a rearmost (or bottommost) layer and a frontmost (or uppermost) layer in a multi-layer optical disc on which reliable recording or reproduction is possible is obtained using the following equation.

$${T}_{0} ( 1 + \frac{{Coma}_{Limit}}{{Coma}_{PU}} ) - {T}_{0} ( 1 - \frac{{Coma}_{Limit}}{{Coma}_{PU}} ) = 2 {T}_{0} \frac{{Coma}_{Limit}}{{Coma}_{PU}}$$

Therefore, when the difference of transmitted layer's thicknesses between the rearmost and frontmost layers is greater than a right-side term of this equation, reliable recording or reproduction cannot be performed on all recording layers using the conventional coma aberration adjustment method. In the example of FIG. 1, reliable recording or reproduction cannot be performed on all recording layers of a multi-layer disc in which the difference of transmitted layer's thicknesses between the rearmost and frontmost layers is greater than 100 μm since Coma_{PU} is 30 mλ, Comaₗᵢₘᵢₜ is 15 mλ, and T₀ is 100 μm.

Taking into consideration this fact, there is suggested a method in which an optimal drive amount of a coma aberration compensating unit in an optical disc recording and reproducing device that records or reproduces data on or from a multi-layer optical disc is previously obtained for each layer so as to minimize the total coma aberration with a light beam being focused on each layer and the drive amount of the coma aberration compensating unit is switched according to the layer when recording or reproduction is actually performed (See Patent Literature 3). In addition, there is also suggested a method in which, instead of optimizing the drive amount of the coma aberration compensating unit for every layer, the drive amount is optimized only for a specific recording layer and the optimized drive amount multiplied by respective factors is applied to other recording layers, thereby reducing the time required to perform the compensation of coma aberration when recording or reproduction is performed on a multi-layer optical disc (See Patent Literature 4).

These Patent Literatures are directed to compensating a transmitted-layer-coma aberration caused when the optical axis of the light beam is inclined with respect to the normal line to the recording layer due to warpage of the optical disc. However, practically, the total coma aberration including both the pickup-coma aberration and the transmitted-layer-coma aberration is compensated by changing the angle of the objective lens or the drive voltage of a liquid crystal panel for compensating coma aberrations since actual pickups inevitably have a pickup-coma aberration due to manufacturing errors of the optical system.
Patent Literature 1: Japanese Patent Application Laid Open No. Hei-10-49877
Patent Literature 2: Japanese Patent Application Laid Open No. Hei-10-31826
Patent Literature 3: WO2003-075266
Patent Literature 4: Japanese Patent Application Laid Open No. 2007-133967

### DISCLOSURE OF THE INVENTION

### Problem to be Solved by the Invention

However, the coma aberration is an aberration having directionality, and, to cancel the pickup-coma aberration, it is generally necessary to adjust the angle of the actuator or objective lens in both the tangential direction (track direction) and the radial direction of the optical disc. Specifically, in Patent Literature 3 or Patent Literature 4, to switch the drive voltage of the coma aberration compensating unit for each recording layer, there is need to mount, on the pickup, a 2-directional coma aberration compensating unit, practically a 4-axis actuator for the objective lens (which is movable in 2 transitional directions for tracking and focusing and in 2 rotational directions, i.e., in tangential and radial directions) and liquid crystal panels for compensating the coma aberration in two directions. In the technology of Patent Literature 4, it is asserted that, when the drive amount has been optimized for only a specific recording layer, it is only necessary to multiply the optimized drive amount by respective factors for other recording layers. This technology is based on the assumption that the transmitted-layer-coma aberration, which is proportional to the transmitted layer's thickness in an optical disc, is the only coma aberration for compensation and thus cannot be applied when the pickup-coma aberration is nonzero. For example, FIGS. 2 and 3 illustrate how the total coma aberration changes in the case where the optical axis of the objective lens and the normal line to the optical disc are inclined with respect to each other due to warpage of the optical disc when the pickup-coma aberration is zero and −30mλ, respectively. Here, a recording layer existing at a transmitted layer's thickness (depth) of 50 μm and a recording layer existing at a transmitted layer's thickness of 300 μm are compared when NA is 0.85, λ is 405 nm, and the optical disc refractive index is 1.6. It can be seen from FIG. 2 that, when the pickup-coma aberration is zero, the ratio of the amounts of coma aberrations occurring in the two recording layers is 6-times, which is equal to the ratio of transmitted layer's thicknesses, regardless of the inclination angle of the optical disc. However, as shown in FIG. 3, the ratio of the amounts of coma aberrations occurring in the two recording layers is not 6-times and instead significantly changes depending on the inclination angle of the optical disc when the pickup-coma aberration is nonzero (−30 mλ).

Therefore, the present invention has been made in view of the above problems, and it is an object of the present invention to provide a coma aberration compensating device with reduced size and a coma aberration compensating-method, wherein pickup-coma aberration is previously compensated for to reduce a load in a recording and reproducing device for the multi-layer optical disc.

It is another object of the present invention to provide a coma aberration compensating device with reduced size and a coma aberration compensating-method, wherein pickup-coma aberration is previously compensated for to simplify optimization of a coma aberration compensating unit and to significantly reduce the time required to perform adjustment when the user has loaded an optical disc.

After a recording and reproducing device for multi-layer optical discs is shipped from the factory, the reliability of recording and reproduction of multi-layer optical discs may not be maintained over a long period due to changes of an optical system in a pickup of the recording and reproducing device which occur over time or due to environmental temperature changes. Therefore, it is another object of the present invention to provide a coma aberration compensating device with reduced size and a coma aberration compensating-method, wherein it is possible to always maintain the state in which pickup-coma aberration is compensated for even when changes occur with time.

### Means for Solving the Problem

In accordance with one aspect of the present invention, the above and other objects can be accomplished by the provision of a compensating device for compensating the coma aberration in a pickup of a recording and reproducing device that records or reproduces data on or from an optical disc using the pickup, the device for compensating coma aberration including an optical system including an objective lens for emitting a light beam to an optical disc including a plurality of recording layers, a first coma aberration compensating device that compensates coma aberration in a body of the optical system, and a second coma aberration compensating device that compensates coma aberration caused by relative inclination of the optical system with respect to the optical disc, wherein the first coma aberration compensating unit and the second coma aberration compensating unit are optimized independently of each other.

The device may further include a focusing device that drives the objective lens to focus the light beam on a surface proximity of the optical disc and on the plurality of recording layers, wherein the first coma aberration compensating unit may optimize a drive voltage of the first coma aberration compensating unit with the light beam being focused on the surface proximity of the optical disc to compensate the coma aberration of the body of the optical system, and the second coma aberration compensating unit may optimize a drive voltage of the second coma aberration compensating unit with the light beam being focused on a recording layer of the optical disc to compensate the coma aberration caused by the relative inclination of the optical system with respect to the optical disc.

The first coma aberration compensating unit may include a first tangential coma aberration compensating unit that compensates coma aberration of a tangential direction and a first radial coma aberration compensating device that compensates coma aberration of a radial direction.

The second coma aberration compensating unit may include a second radial coma aberration compensating unit that compensates coma aberration of a radial direction.

The first radial coma aberration compensating unit and the second radial coma aberration compensating unit may be an identical radial coma aberration compensating device and a drive voltage of the first radial coma aberration compensating unit optimized by the first coma aberration compensating unit may be used as a reference value of a drive voltage of the second radial coma aberration compensating unit.

The first tangential coma aberration compensating unit may include a transmissive liquid crystal panel including transparent electrodes having a coma aberration compensating pattern for compensating the coma aberration of a tangential direction through the drive voltage.

The first radial coma aberration compensating unit may be a transmissive liquid crystal panel including transparent electrodes having a coma aberration compensating pattern for compensating the coma aberration of a radial direction through the drive voltage.

The first radial coma aberration compensating unit may be a tilting device for tilting the objective lens in a radial direction from an optical axis of the objective lens according to the drive voltage.

In accordance with another aspect of the present invention, the above and other objects can be accomplished by the provision of a method for compensating the coma aberration in a pickup of a recording and reproducing device that records or reproduces data on or from an optical disc using the pickup, the method including a first coma aberration compensating step to compensate coma aberration in a body of an optical system including an objective lens for emitting a light beam to an optical disc including a plurality of recording layers, and a second coma aberration compensating step to compensate coma aberration caused by relative inclination of the optical system with respect to the optical disc.

The method may further include a focusing step to drive the objective lens to focus the light beam on a surface proximity of the optical disc and on the plurality of recording layers, wherein, at the first coma aberration compensating step, the coma aberration of the body of the optical system may be compensated with the light beam being focused on the surface proximity of the optical disc in the optical system, and, at the second coma aberration compensating step, the drive voltage of the second coma aberration compensating step may be optimized and the coma aberration caused by the relative inclination of the optical system with respect to the optical disc may be compensated with the light beam being focused on a recording layer of the optical disc in the optical system.

In this coma aberration compensating-method, initially, the first coma aberration compensating unit is optimized such that remaining coma aberration is reduced with a light beam being focused on the optical disc surface, thereby compensating coma aberration (including no transmitted-layer-coma aberration) that is present only in the pickup optical system. Thereafter, the light beam is focused on a specific recording layer (preferably, the deepest layer) different from the optical disc surface and the second coma aberration compensating unit is then optimized such that remaining coma aberration is reduced with the light beam being focused on the specific recording layer, thereby compensating transmitted-layer-coma aberration. Accordingly, it is possible to quickly reduce total coma aberration of all recording layers.

In accordance with another aspect of the present invention, the above and other objects can be accomplished by the provision of an optical disc including a plurality of recording layers on or from which information is recorded or reproduced, and a pattern region for compensating the coma aberration formed on a surface proximity of the optical disc on a front side thereof when viewed in an emitting direction of a light beam from a pickup that records or reproduces information on the recording layers, the pattern region for compensating the coma aberration including periodic patterns formed in the pattern region for detecting the amount of coma aberration in a body of an optical system including the pickup.

The pattern region for compensating the coma aberration may include a pattern area for compensation of the radial coma aberration and a pattern area for compensation of the tangential coma aberration.

The pattern area for compensation of the radial coma aberration may include single-periodic patterns having a period of λ/(0.75*NA) parallel to a tangential direction when a numerical aperture of an objective lens is “NA” and a wavelength for recording or reproduction is λ.

The pattern area for compensation of the tangential coma aberration may include single-periodic patterns having a period of λ/(0.75*NA) parallel to a radial direction when a numerical aperture of an objective lens is “NA” and a wavelength for recording or reproduction is λ.

The patterns of the pattern region for compensating the coma aberration may be formed in at least one of a concavo and convex structure, a phase-change structure, a reflectance-change structure, and any hybrid structure thereof.

An interval between a nearest recording layer and a most distant recording layer among the plurality of recording layers when viewed in an emission direction of the light beam from the pickup may be at least 100 μm.

### BRIEF DESCRIPTION OF THE DRAWINGS

FIG. 1 is a graph illustrating characteristics of total coma aberrations versus thicknesses of transmitted layers in a multi-layer optical disc.

FIG. 2 is a graph illustrating characteristics of total coma aberration versus an angle between the normal line to an optical disc and the optical axis of an objective lens.

FIG. 3 is a graph illustrating characteristics of total coma aberration versus an angle between the normal line to an optical disc and the optical axis of an objective lens.

FIG. 4 illustrates a schematic configuration of a recording medium according to an embodiment of the present invention and a recording and reproducing system that records or reproduces data on or from the recording medium.

FIG. 5 is a schematic perspective view of a multi-layer optical disc according to an embodiment of the present invention.

FIG. 6 is a partially enlarged plan view of a multi-layer optical disc according to the embodiment.

FIG. 7 is a partially enlarged plan view of a multi-layer optical disc according to the embodiment.

FIG. 8 is a partially enlarged plan view of a multi-layer optical disc according to the embodiment.

FIG. 9 is a graph illustrating characteristics of coma aberration versus thicknesses of the transmitted layer in a multi-layer optical disc according to an embodiment.

FIG. 10 is a graph illustrating respective MTF curves when pickup-coma aberration is present and when pickup-coma aberration is absent.

FIG. 11 is a graph illustrating a SUM signal amplitude and a push pull signal amplitude of a multi-layer optical disc according to the embodiment.

FIG. 12 is a partially enlarged cross-sectional view of a multi-layer optical disc according to the embodiment.

FIG. 13 is a block diagram illustrating a configuration of a coma aberration compensating device according to an embodiment of the present invention.

FIG. 14 is a schematic cross-sectional view illustrating a spherical aberration compensation unit in the coma aberration compensating device according to an embodiment of the present invention.

FIG. 15 is a block diagram illustrating a configuration of a coma aberration compensating device according to another embodiment of the present invention.

FIG. 16 is a schematic cross-sectional view illustrating a liquid crystal optical element which is a spherical aberration compensation unit in the coma aberration compensating device according to another embodiment of the present invention.

FIG. 17 is a front elevation view illustrating electrodes of a liquid crystal optical element which is a coma aberration compensating-unit in the coma aberration compensating device according to another embodiment of the present invention.

FIG. 18 is a front elevation view illustrating electrodes of a liquid crystal optical element which is a coma aberration compensating-unit in the coma aberration compensating device according to another embodiment of the present invention.

FIG. 19 is a front elevation view illustrating electrodes of a liquid crystal optical element which is a spherical aberration compensation unit in the coma aberration compensating device according to another embodiment of the present invention.

FIG. 20 is a flow chart illustrating a coma aberration compensating-method according to an embodiment of the present invention.

FIG. 21 is a flow chart illustrating a coma aberration compensating-method according to another embodiment of the present invention.

FIG. 22 is a flow chart illustrating a coma aberration compensating-method according to another embodiment of the present invention.

FIG. 23 is a flow chart illustrating a coma aberration compensating-method according to another embodiment of the present invention.

FIG. 24 is a block diagram illustrating a configuration of a coma aberration compensating device to explain a coma aberration compensating-method according to another embodiment of the present invention.

FIG. 25 is a flow chart illustrating a coma aberration compensating-method according to another embodiment of the present invention.

FIG. 26 is a block diagram illustrating controlling of compensation of the coma aberration of an aberration controller in a coma aberration compensating device according to an embodiment of the present invention.

FIG. 27 is a block diagram illustrating controlling of compensation of the coma aberration of a coma aberration control initialization unit in a coma aberration compensating device according to an embodiment of the present invention.

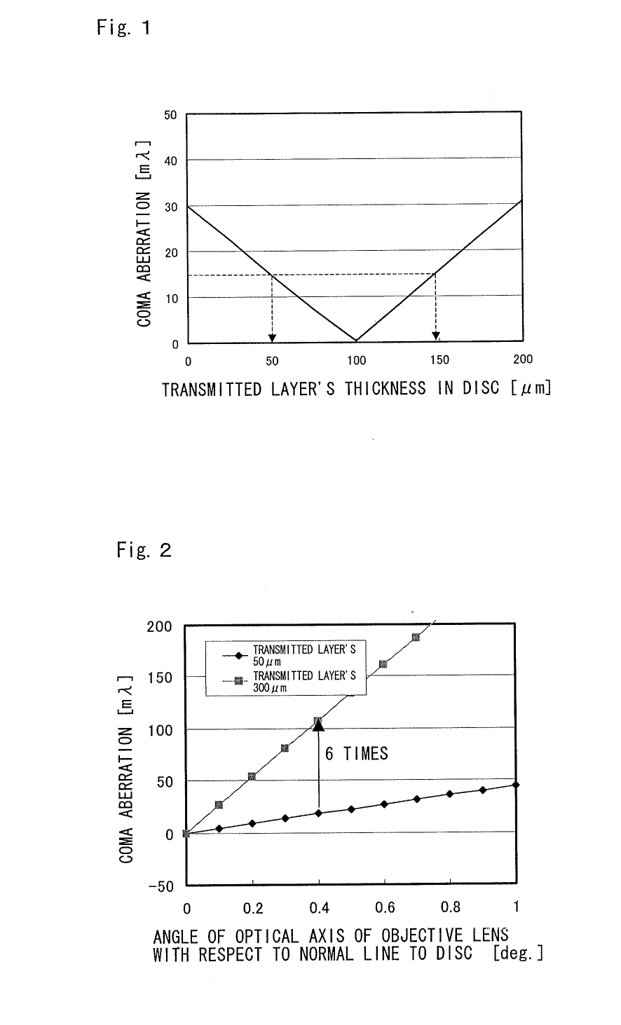

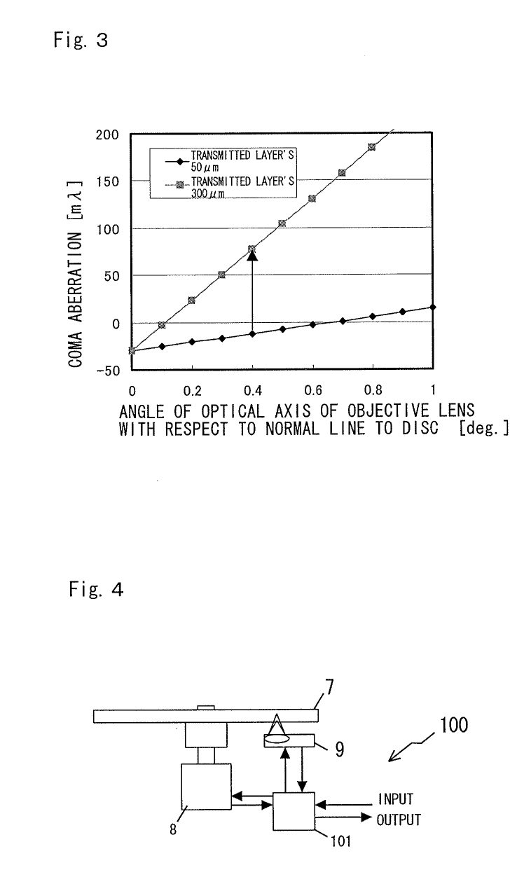

### EXPLANATION OF REFERENCE NUMERALS

9 Pickup
10 . . . Coma aberration compensating device
12 . . . Light source
13 . . . Collimating lens
14 . . . Beam splitter
15 . . . Aberration compensating unit
16 . . . Actuator
17 . . . Objective lens
19 . . . Optical detector
21 . . . Signal processing circuit
23 . . . Spherical aberration detecting circuit
24 . . . Coma aberration detecting circuit
27 . . . Aberration controller
30 . . . Coma aberration control initialization unit

### MODE FOR CARRYING OUT THE INVENTION

Embodiments of the present invention will now be described with reference to the accompanying drawings.

<Recording and Reproducing Device>

FIG. 4 illustrates a schematic configuration of a recording medium according to an embodiment of the present invention and a recording and reproducing system that records or reproduces data on or from the recording medium.

As shown in FIG. 4, a recording and reproducing device 100 includes a spindle motor 8, a pickup 9, and a control device 101. The spindle motor 8 includes a clamper that rotatably supports an optical disc 7. The pickup 9 includes an objective lens for emitting a light beam for recording or reproduction to the optical disc 7. The control device 101 controls these components. Specifically, the control device 101 controls the spindle motor 8 and the pickup 9 based on a variety of output data from a variety of sensors provided on the spindle motor 8 and the pickup 9 and processes the variety of output data. According to a signal from the control device 101, the pickup 9 emits a light beam to the optical disc 7 while controlling the location of the light beam with respect to the optical disc 7 that is being rotated and records a recording arc on the optical disc 7 or reproduces recorded data from the optical disc 7. The control device 101 receives a signal produced from a return beam of the light beam from the pickup 9 and decodes and outputs the received signal.

<Recording Medium>

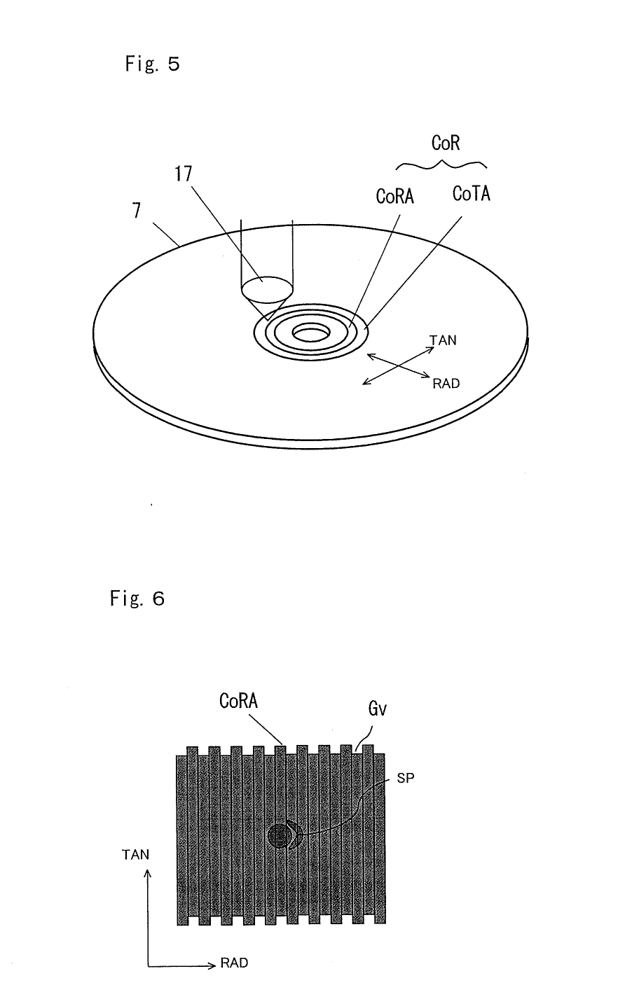

FIG. 5 is a schematic perspective view of a multi-layer optical disc 7 according to an embodiment of the present invention.

While the pickup-coma aberration and the transmitted-layer-coma aberration are canceled in the conventional coma aberration compensating-method, the present invention is characterized in that a first coma aberration compensating step at which only the pickup-coma aberration is compensated and a second coma aberration compensating step at which only the transmitted-layer-coma aberration is compensated are performed in order, thereby compensating the total coma aberration without canceling the pickup-coma aberration and the transmitted-layer-coma aberration.

Therefore, at the first coma aberration compensating step, it is necessary to perform compensation of coma aberration with a light beam being focused on a portion of the optical disc near the optical disc surface, which will also be referred to as “optical disc surface proximity”, to prevent the occurrence of the transmitted-layer-coma aberration.

In the case where the first coma aberration compensating step is performed at the stage of assembling the recording and reproducing device at the factory, it is possible to perform adjustment so as to reduce the pickup-coma aberration, for example by focusing a laser beam on a surface of a test optical disc and directly observing the shape of the focus spot using a microscope. However, in the case where the first coma aberration compensating step is performed by the user, there is a need to previously form periodic patterns for compensation of the pickup-coma aberration, whose reproduction signal varies in magnitude according to the amount of the pickup-coma aberration, on the surface of the optical disc since it is practically impossible to directly observe the shape of the focal spot using a microscope.

Since the pickup-coma aberration is directional, there is a need to compensate the pickup-coma aberration in at least two directions, namely, radial and tangential directions, as described above. Therefore, it is preferable that the periodic patterns for compensation of the pickup-coma aberration, which are previously formed on the surface of the optical disc, be defined in both the radial direction RAD and the tangential direction TAN so as to be read through the objective lens 17.

The multi-layer optical disc 7 illustrated in FIG. 5 includes a plurality of recording layers (not shown) that will be described later, on or from which information is recorded or reproduced, and a pattern region for compensation of the pickup-coma aberration CoR, which is formed on the surface proximity of the multi-layer optical disc 7 on the front side thereof when viewed in the emitting direction of the light beam from the pickup, and on which periodic patterns for detecting the amount of the pickup-coma aberration are formed. The pattern region for compensation of the pickup-coma aberration CoR includes a pattern area for compensation of the radial pickup-coma aberration CoRA and a pattern area for compensation of the tangential pickup-coma aberration CoTA which are concentrically arranged sequentially in the inward direction on a portion of the surface of the multi-layer optical disc 7 outside a lead-in region that is defined around a center hole of the optical disc. Alternatively, the pattern area for compensation of the radial pickup-coma aberration CoRA may be disposed at the outer side in the pattern region for compensation of the pickup-coma aberration CoR while the pattern area for compensation of the tangential pickup-coma aberration CoTA is disposed at the inner side. The patterns for compensation of each of the pattern areas may be formed not only in a periodic groove structure but also in a concavo-convex structure, a phase-change structure, a reflectance-change structure, or any hybrid structure thereof. For example, as in a conventional recordable optical disc, a phase-change or pigment-type recording film may be formed in a predetermined area on the surface of the optical disc and recording may thereafter be performed on the recording film using a beam dedicated to forming the patterns. Although the patterns are formed in the inner peripheral section of the optical disc in this embodiment, the patterns may be formed in the outer peripheral section of the optical disc, may be formed intermittently, and may be formed on any portion of the surface of the optical disc unless such formation interferes with reading data from or writing data to the recording layer.

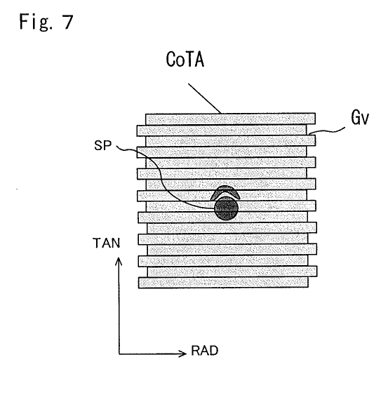

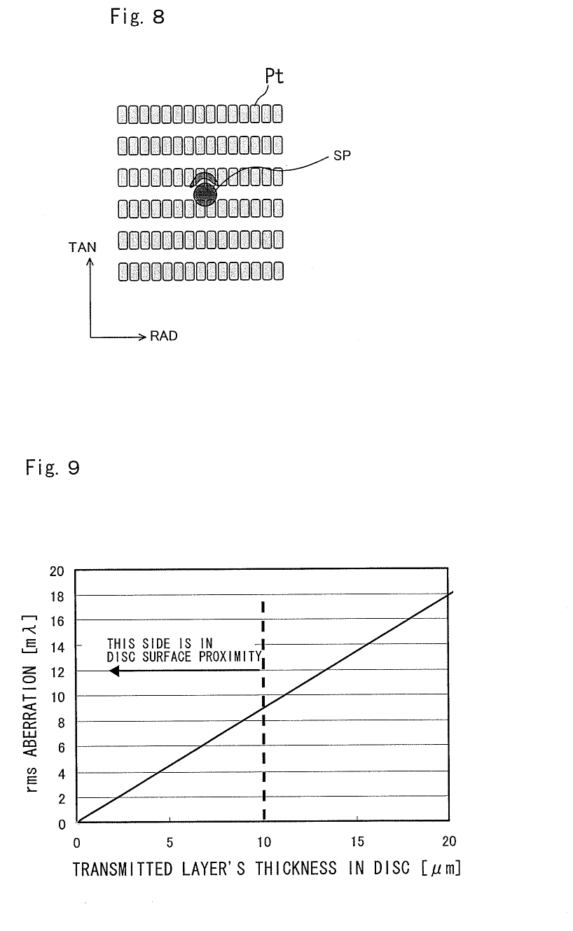

As shown in FIGS. 6 and 7, periodic groove patterns Gv extending in the tangential direction TAN are formed in the pattern area for compensation of the radial pickup-coma aberration CoRA and periodic groove patterns Gv extending in the radial direction RAD are formed in the pattern area for compensation of the tangential pickup-coma aberration CoTA so that a read spot SP is read through the objective lens 17. For example, the pattern area for compensation of the tangential pickup-coma aberration CoTA may be formed by arranging grooves more densely in the radial direction than in the tangential direction such that a pitch Pt between grooves in the radial direction is smaller than a pitch in the tangential direction as shown in FIG. 8.

Since the pattern region for compensation of the pickup-coma aberration CoR including the patterns for monitoring the amount of pickup-coma aberration is previously formed on the surface of the optical disc, it is possible for the user to perform the first coma aberration compensating step, at which the user compensates the pickup-coma aberration while indirectly observing the beam spot, using a detection signal output from an optical detection unit with a focused light beam.

The inventor has found an optimal condition of the surface of the optical disc on which the pattern region for compensation of the pickup-coma aberration CoR is formed. That is, the inventor has found the maximum allowable thickness or depth of the “disc surface” or “disc surface proximity”.

Theoretically, in the case where the pickup-coma aberration is canceled using a first coma aberration compensating device such as an objective lens angle adjustment device or an actuator angle adjustment device that is used in an embodiment described later, the “disc surface” or “disc surface proximity” is defined to be a portion having a transmitted layer's thickness or depth of the recording layer at which the transmitted-layer-coma aberration is regarded as sufficiently small regardless of the status of the first coma aberration compensating unit.

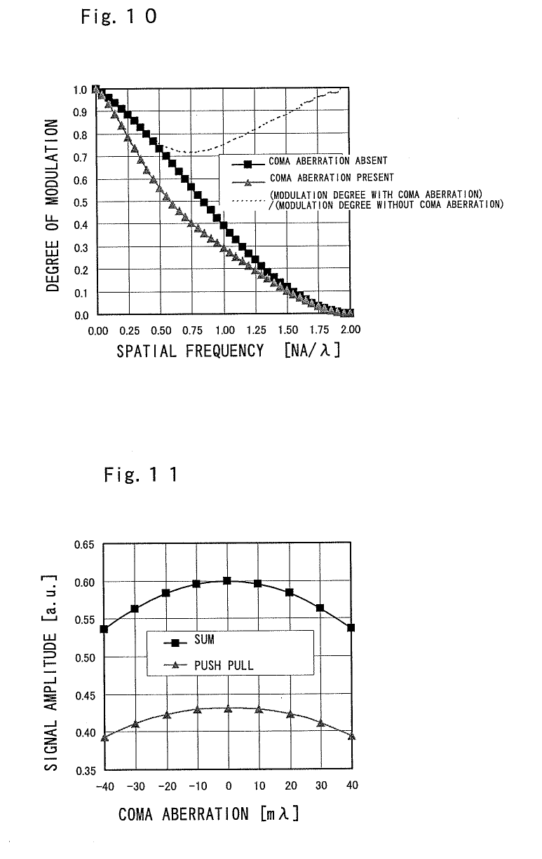

For example, if the amount of transmitted-layer-coma aberration is plotted while changing the transmitted layer's thickness in the optical disc with the maximum compensation angle of the coma aberration compensating unit being assumed to be 1 degree when NA is 0.85, λ is 405 nm, and “n” is 1.6 of the refractive index of transmitted layer in the optical disc, it is possible to obtain the characteristics of the transmitted layer's thickness versus rms aberration illustrated in a graph of FIG. 9.

Taking into consideration that the assembly or manufacturing accuracy of the optical parts of the pickup suffers from a pickup-coma aberration of at least 30 mλ, there is a need to reduce the transmitted-layer-coma aberration below 10 mλ. To accomplish this, there is a need to set the optical disc surface proximity to be a range of 10 μm or less in depth from the optical disc surface.

That is, if the beam is focused while a range of 10 μm or less in depth from the optical disc surface is regarded as the optical disc surface proximity, the transmitted-layer-coma aberration is suppressed to be sufficiently small regardless of the angle of the objective lens or the actuator, and therefore it is possible to optimize the first coma aberration compensating unit such that only the pickup-coma aberration is compensated.

The inventor has also found an optimal pattern period of the pattern region for compensation of the pickup-coma aberration CoR.

FIG. 10 is a graph illustrating respective MTF curves when coma aberration is present and when coma aberration is absent. The horizontal axis of the graph represents a spatial frequency, which is equal to the reciprocal of the pattern period, and the vertical axis is the degree of amplitude modulation of the detection signal. When the ratio of the degrees of amplitude modulation when coma aberration is present and when coma aberration is absent is plotted as shown by a dotted line, it can be seen that the degree of amplitude modulation is most sensitive to the presence or absence of coma aberration when the spatial frequency is about 0.75 [NA/λ.]. For example, as is apparent from FIG. 10, when NA=0.85 and λ=0.405 μm, periodic patterns having a period of about 0.64 μm can be considered desirable patterns for detection of the coma aberration. Accordingly, it is preferable that, when the numerical aperture of the objective lens is “NA” and the wavelength for recording or reproduction is λ, the patterns for compensations of tangential and radial pickup-coma aberrations be single-periodic patterns having a period of λ/(0.75*NA) parallel to the radial and tangential directions, respectively.

FIG. 11 is a graph illustrating a SUM signal amplitude and a push-pull signal amplitude when a beam for reproduction has crossed a groove structure having a period of 0.64 μm when NA=0.85 and λ=0.405 μm. From FIG. 11, it can be seen that the amount of pickup-coma aberration can be reduced to zero, for example by optimizing the first coma aberration compensating unit so that the signal amplitude is maximized.

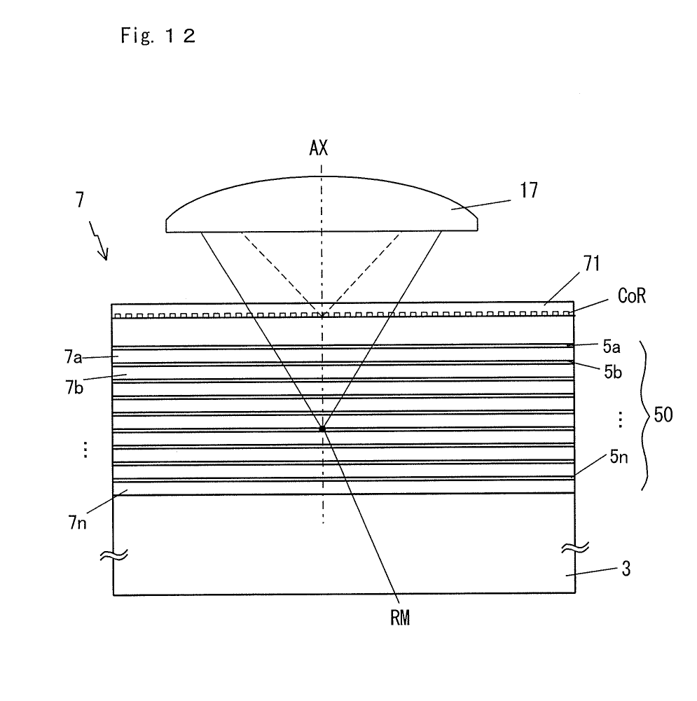

FIG. 12 is a partially enlarged cross-sectional view of a multi-layer optical disc 7 having a plurality of recording layers for recording or reproducing information. The multi-layer optical disc 7 includes a surface protecting layer 71, a pattern region for compensation of the pickup-coma aberration CoR, a recording layer group 50, and a support substrate 3, which are sequentially arranged in the incidence direction of the laser beam.

The surface protecting layer 71 includes an optically transmissive material and has a thickness of 10 μm or less and serves to flatten the stack structure and to protect the recording layer group 50 and the like.

The pattern region for compensation of the pickup-coma aberration CoR may include periodic concavo-convex or reflectance-change patterns formed for detecting the amount of pickup-coma aberration.

The recording layer group 50 is a stack of recording layers 5, in each of which information is recorded. Specifically, the recording layer group 50 is a stack of optically transmissive layers that are stacked parallel to each other, namely a first recording layer 5a, a first separating layer 7a, a second recording layer 5b, a second separating layer 7b, . . . , an n-th recording layer 5n, and an n-th separating layer 7n. Here, when the multi-layer optical disc 7 is a read-only disc, the recording layer is a layer on which phase pits or the like have already been formed and, when the multi-layer optical disc 7 is a write-once or rewritable disc, the recording layer is a layer on which not only a phase-change film, a pigment film or the like is coated as in DVD or BD but a two-photon absorbing material or the like described above is also coated. Examples of the material of the recording layer include those described in Japanese Patent Application Publication No. 2005-190609 or Japanese Patent Application Publication No. 2007-59025.

When the first coma aberration compensating step is performed, the objective lens 17 focuses a laser beam (shown by a dashed line) on the pattern region for compensation of the pickup-coma aberration CoR and, when recording or reproduction is performed, the objective lens 17 focuses a laser beam (shown by a solid line) on a focal point of each recording layer 5 of the recording layer group 50 to three-dimensionally record or reproduce data (or a recording mark RM). The objective lens 17 having a predetermined numerical aperture emits a focused beam and collects a beam reflected from the recording layer group 50. The focused beam is emitted to a recording layer of the recording layer group 50 through the surface protecting layer 71 to record or read a signal on or from the recording layer, thereby recording or reproducing information.

Although the pattern region for compensation of the pickup-coma aberration CoR and a region of the recording layers in which information is recorded are illustrated as overlapping each other in FIG. 12, actually, the pattern region for compensation of the pickup-coma aberration CoR can be formed in a special region such as the inner or outer peripheral section of the optical disc so as not to interfere with reading data from or writing data to the recording layer.

The support substrate 3 includes, for example, glass, plastics such as polycarbonate, or amorphous polyolefin, polyimide, PET, PEN, or PES, or an ultraviolet curing acrylic resin. The optical disc 7 may not only be disc-shaped as described above but may also be card-shaped.

### <COMA ABERRATION Compensating Device>

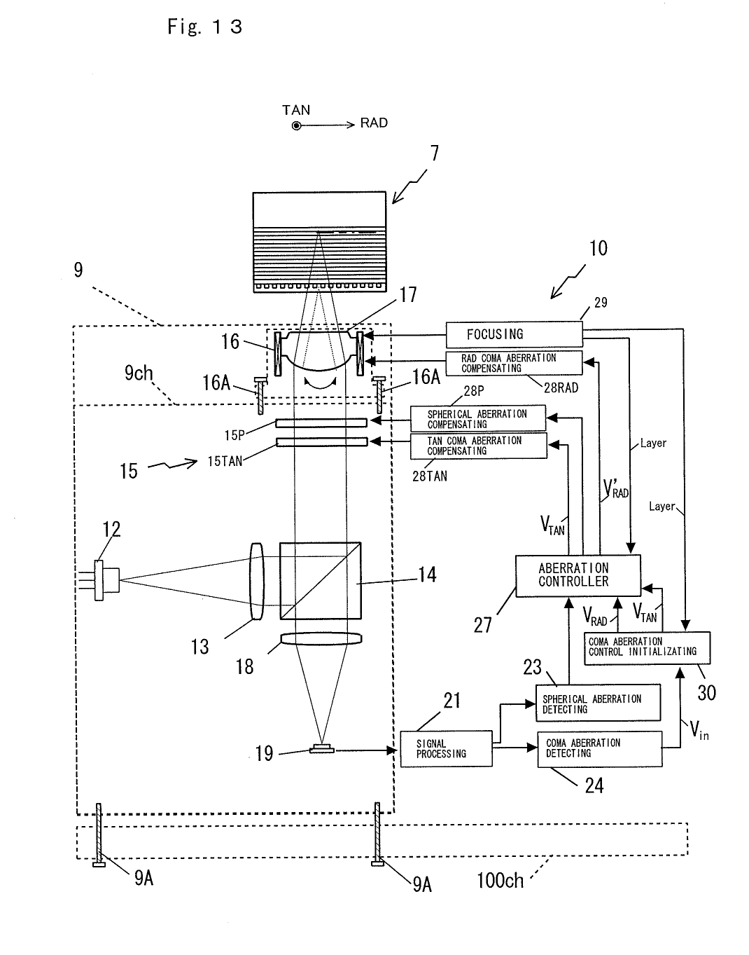

FIG. 13 is a block diagram illustrating a configuration of a coma aberration compensating device 10 having an aberration compensation function according to an embodiment of the present invention.

A laser light source 12 mounted on a pickup 9 emits, for example, laser beams having a wavelength of λ=405 nm. Light beams emitted by the laser light source 12 are converted into a parallel beam through a collimating lens 13. The light beam then passes through a beam splitter 14 and an aberration compensating device 15 and is then focused by an objective lens 17. Through the beam focusing, a focal point is formed on an information recording surface of an optical disc 7 (as shown by a solid line) when the second coma aberration compensating step is performed or when information recording or reproduction is performed and a focal point is formed on the surface of the optical disc 7 (as shown by a dotted line) when the coma aberration compensating unit is initialized.

The objective lens 17 is held and driven by an actuator 16.

The actuator 16 is driven by a focusing driver 29 and drives the objective lens to focus a light beam on the surface of the optical disc or on the information recording surface of a recording layer of the recording layer group 50. The focusing driver 29 provides position data of the surface on which the light beam is being focused to a coma aberration control initialization unit 30 of an aberration controller which will be described later.

The actuator 16 is fixed to a chassis 9ch of the pickup 9. The actuator 16 includes an angle adjustment mechanism 16A that is used to change the inclination of the actuator 16 with respect to the chassis 9ch of the pickup 9 when the actuator 16 is fixed to the chassis 9ch. Specific examples of the angle adjustment mechanism include so-called screwing described in Patent Literature 2 (Japanese Patent Application Publication No. 10-31826). The pickup 9 is fixed to a chassis 100ch of the recording and reproducing device. The pickup 9 includes an angle adjustment mechanism 9A that is used to change the inclination of the pickup 9 with respect to the spindle motor 8 and thus with respect to the optical disc when the pickup 9 is fixed to the chassis 100ch. Specific examples of the inclination adjustment mechanism also include so-called screwing described in Patent Literature 2 (Japanese Patent Application Publication No. 10-31826).

As described later, the angle adjustment mechanism functions as the aberration compensating unit 15 when adjustment for compensating the coma aberration is performed at the stage of assembling the recording and reproducing device at the factory.

A light beam reflected by the optical disc 7 is collected by the objective lens 17 and is then detected by the optical detector 19 via the aberration compensating unit 15, the beam splitter 14, and the focusing lens 18. The actuator 16 is also driven by a tracking driver (not shown).

Examples of the actuator 16 include a three-axes actuator as shown in FIG. 4 of Patent Literature 3 (International Patent Publication No. 2003-075266). Part of the functionality of the three-axes actuator is included in the aberration compensating unit 15. The three-axes actuator has a function to incline the objective lens 17 in the radial direction from the optical axis thereof according to a drive voltage so as to compensate coma aberration (in the radial direction RAD) that is symmetrical with respect to the straight line of the tangential direction TAN.

A reproduction signal that the optical detector 19 generates through detection of the light beam is transmitted to a signal processing circuit 21. The signal processing circuit 21 generates data required to control the aberration compensating unit 15 from the received reproduction signal and provides the generated data to a spherical aberration detecting circuit 23 and a coma aberration detecting circuit 24. More specifically, the signal processing circuit 21 extracts data such as envelope amplitude data of pre-groove or read data (RF data) and provides the extracted data to the spherical aberration detecting circuit 23 and the coma aberration detecting circuit 24.

The spherical aberration detecting circuit 23 generates an optimal compensation voltage for compensating the spherical aberration based on the envelope amplitude data and provides the optimal compensation voltage to the aberration controller 27.

The coma aberration detecting circuit 24 generates an optimal compensation voltage Vᵢₙ for compensating the coma aberration based on the envelope amplitude data and provides the optimal compensation voltage to the coma aberration control initialization unit 30.

The coma aberration control initialization unit 30 performs a different operation depending on a position data layer of the surface on which the light beam is being focused based on the data provided from the focusing driver 29 as shown in FIG. 27. At the first coma aberration compensating step, the light beam is focused on the optical disc surface (A), and the input voltage Vᵢₙ, is stored as V_{TAN} in a memory when the pattern area for compensation of the tangential pickup-coma aberration CoTA is reproduced and the input voltage Vᵢₙ is stored as V_{offset} in the memory when the pattern area for compensation of the radial pickup-coma aberration CoRA is reproduced. On the other hand, a value obtained by subtracting V_{offset} from the input voltage Vᵢₙ is stored as V_{RAD} in the memory when the light beam is focused on a specific recording layer at the second coma aberration compensating step (B).

The aberration controller 27 performs controlling of compensation of the coma aberration by driving the aberration compensating unit 15 based on data provided from each of the focusing driver 29, the spherical aberration detecting circuit 23, and the coma aberration control initialization unit 30.

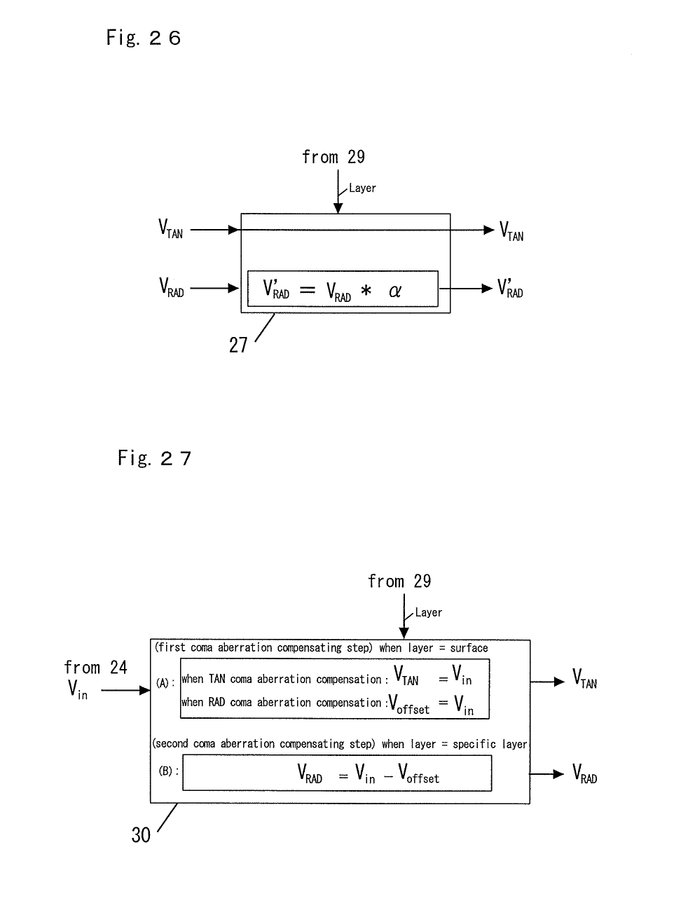

As shown in FIG. 26, upon receiving V_{TAN} and V_{RAD} as aberration signals from the coma aberration control initialization unit 30, the aberration controller 27 directly outputs V_{TAN} as a drive voltage of a TAN coma aberration compensating-driver 28TAN to drive a TAN coma aberration compensating-unit 15TAN. The aberration controller 27 also outputs, as a drive voltage of an RAD coma aberration compensating-driver 28RAD, a voltage obtained by multiplying V_{RAN} by a predetermined factor α to the three-axes actuator 16 to drive the RAD coma aberration compensating-driver 28RAD (for lens inclination control). Here, the predetermined factor α is equal to the ratio of a transmitted layer's thickness above the recording layer, on which the beam is being focused, to a transmitted layer's thickness above the specific recording layer (i.e., α=(transmitted layer's thickness on focused recording layer)/(transmitted layer's thickness on specific recording layer)).

Using the respective drive voltages, the aberration controller 27 drives the TAN coma aberration compensating-unit 15TAN and the three-axes actuator 16 through the TAN coma aberration compensating-driver 28TAN and the RAD coma aberration compensating-driver 28RAD, respectively. The TAN coma aberration compensating-unit 15TAN has a function to compensate coma aberration (in the tangential direction) that is symmetrical with respect to the straight line of the radial direction.

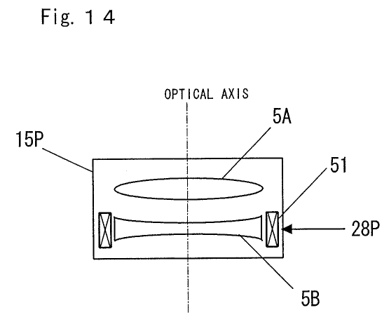

FIG. 14 illustrates an example of the spherical aberration compensation unit 15P included in the aberration compensating unit 15. The spherical aberration compensation unit 15P includes a concave lens 5A and a convex lens 5B that are coaxial with the optical axis and a device 51 for electromechanically changing an interval between the two lenses along the optical axis. The spherical aberration compensation unit 15P is driven by a drive current from the spherical aberration compensation driver 28P and changes the lens interval to compensate the spherical aberration.

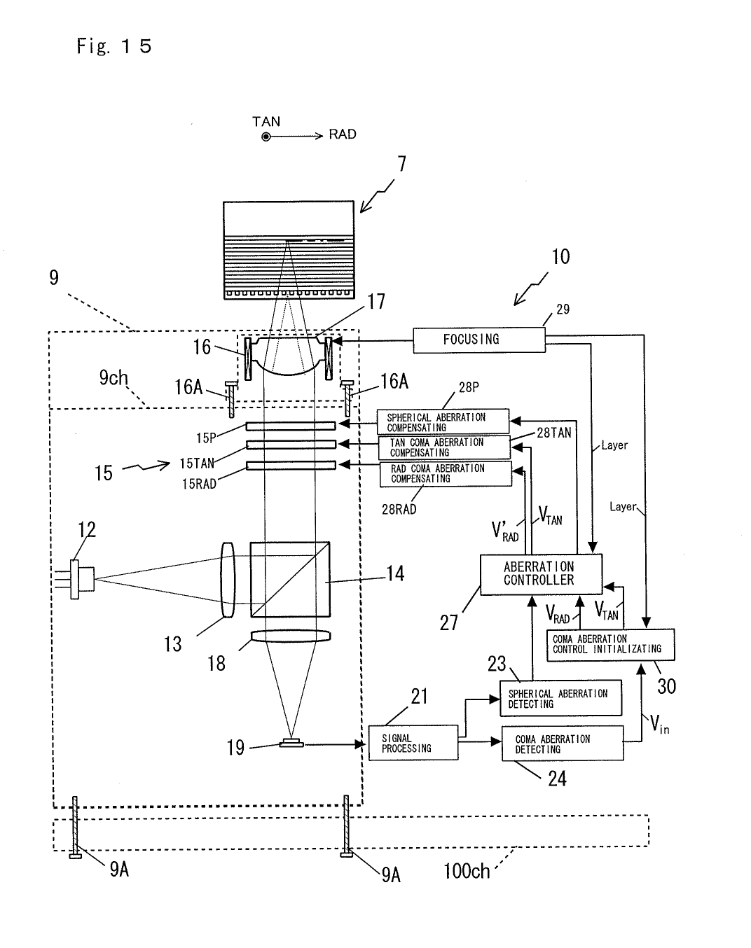

FIG. 15 is a block diagram illustrating a configuration of a coma aberration compensating device 10 having an aberration compensation function according to another embodiment of the present invention. The coma aberration compensating device 10 shown in FIG. 15 is identical to that of FIG. 13, except that a three-axes actuator is employed instead of the 2-axis actuator, an RAD coma aberration compensating-unit 15RAD formed of a liquid crystal optical element disposed coaxially with the other aberration compensation units is provided, and the spherical aberration compensation unit 15P is replaced with a liquid crystal optical element. The RAD coma aberration compensating-unit 15RAD has a function to compensate coma aberration (in the radial direction) that is symmetrical with respect to the straight line of the tangential direction. Each of the coma aberration compensating-unit and the spherical aberration compensation unit is, for example, a known liquid crystal optical element.

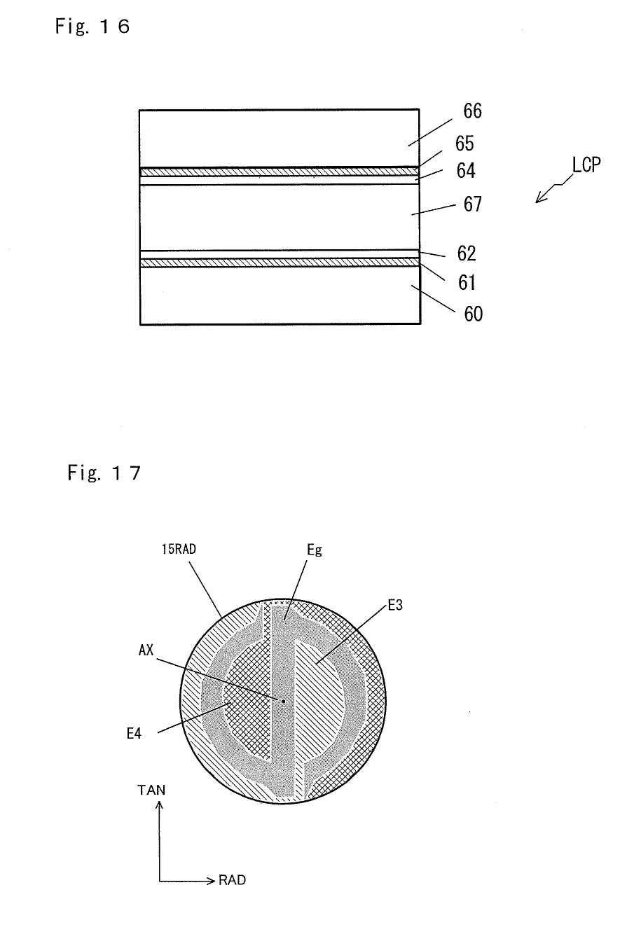

FIG. 16 illustrates a schematic cross-sectional view of a liquid crystal optical element LCP. A first ITO transparent electrode 61 and a second ITO transparent electrode 65 are deposited, respectively, on an inner surface of a first glass substrate 60 and an inner surface of a second glass substrate 66 which face each other. The first and second ITO transparent electrodes 61 and 65 apply an external voltage signal to a liquid crystal layer 67 and allow light to be transmitted through the electrodes 61 and 65. A first polyvinyl alcohol alignment film 62 and a second polyvinyl alcohol alignment film 64 are deposited, respectively, on the first ITO transparent electrode 61 and the second ITO transparent electrode 65. The first and second polyvinyl alcohol alignment films 62 and 64 control the alignment of the liquid crystal layer 67. The liquid crystal layer 67 is sealed with an epoxy resin layer or the like, surrounding the liquid crystal layer 67, to prevent from leakage of liquid crystal. By applying a voltage to the transparent electrode pattern of the liquid crystal element, it is possible to arbitrarily control the refractive index distribution of cross-sectional surfaces in the liquid crystal layer 67 which are vertical to the travel direction of the light beam that is transmitted through the liquid crystal layer, and it is possible to control the wavefront phase of the light beam according to the transparent electrode pattern.

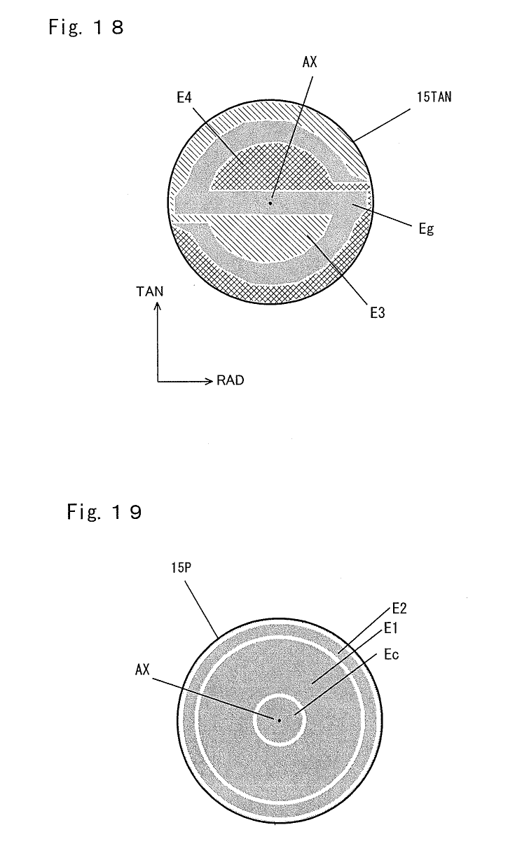

In the case where the RAD coma aberration compensating-unit 15RAD is formed of such a liquid crystal optical element, the first ITO transparent electrode 61 is patterned and divided into three regions Eg, E3, and E4 with patterns that are symmetrical with respect to the straight line of the tangential direction as shown in FIG. 17 in order to compensate coma aberration (in the radial direction) that is symmetrical with respect to the straight line of the tangential direction. In the case where the TAN coma aberration compensating-unit 15TAN is formed of such a liquid crystal optical element, the first ITO transparent electrode 61 is patterned and divided into three regions Eg, E3, and E4 with patterns that are symmetrical with respect to the straight line of the radial direction as shown in FIG. 18 in order to compensate coma aberration (in the tangential direction) that is symmetrical with respect to the straight line of the radial direction. A gap is defined between each of the transparent electrodes Eg, E3, and E4 such that they are electrically separated from each other.

In the case where the aberration compensating unit 15 is formed of such a liquid crystal optical element, the second ITO transparent electrode 65 is patterned and divided into three regions Ec, E1, and E2 with transparent electrode patterns that are concentrically formed as shown in FIG. 19 in order to compensate a spherical aberration (in the tangential direction) that is symmetrical with respect to the optical axis. The spherical aberration compensation unit 15P is also driven by the aberration controller 27 through the spherical aberration compensation driver 28P.

Procedures of the aberration compensation operation of the coma aberration compensating device will now be described with reference to flow charts.

### Embodiment 1

The following is a description of a compensation process of coma aberration that is performed before recording or reproducing is performed on the optical disc 7 shown in FIG. 5 in a recording and reproducing device including the coma aberration compensating device shown in FIG. 13. Specifically, the compensation process of coma aberration is a procedure in which both the first coma aberration compensating step and the second coma aberration compensating step are performed until recording or reproducing is initiated when the user has loaded a disc into a recording and reproducing device in which a three-axes actuator serves as both a first radial coma aberration compensating device and a second radial coma aberration compensating device.

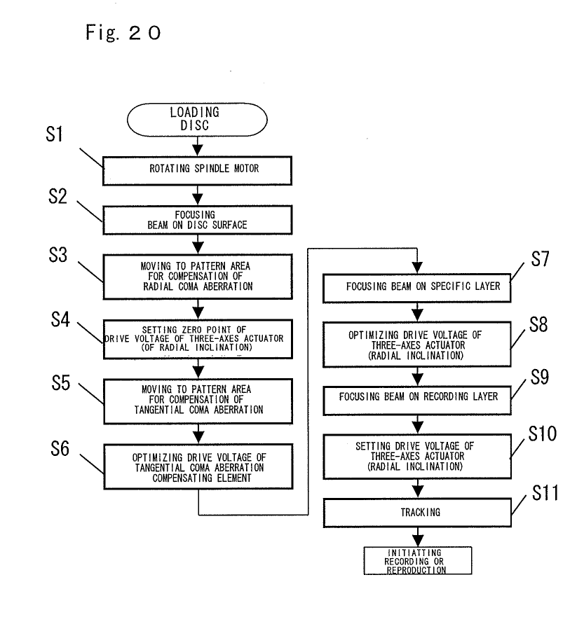

The compensation process of coma aberration shown in the flow chart of FIG. 20 is performed in the following manner.

First, the first coma aberration compensating step is performed. Specifically, when an optical disc 7 is inserted into the recording and reproducing device shown in FIG. 4, the spindle motor 8 is rotated (step S1) and a light beam is then focused on the surface of the optical disc 7 (step S2). Here, the spherical aberration compensation unit 15P is driven so as to minimize spherical aberration.

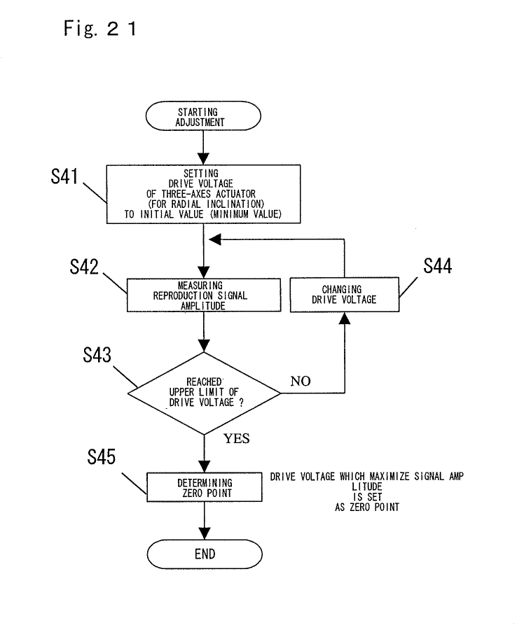

The pickup 9 is then moved to the pattern area for compensation of the radial pickup-coma aberration CoRA (step S3) and V_{offset} is stored in a memory as a reference point of the three-axes actuator 16 which functions as the first radial coma aberration compensating unit in this process (step S4). Here, for example, a procedure shown in a flow chart of FIG. 21 is performed in the following manner. First, after a lens inclination drive voltage of the three-axes actuator 16 is minimized, an envelope amplitude output from the signal processing circuit 21 in combination with the drive voltage is input to the memory through the coma aberration detecting circuit 24 (step S41). Since the eccentricity of the optical disc is generally not small, a reproduction signal amplitude is obtained in the pattern area for compensation of the radial pickup-coma aberration CoRA as the reproduction beam spot SP moves across the pattern area for compensation of the radial pickup-coma aberration CoRA. If the eccentricity is zero, the envelope amplitude output from the signal processing circuit 21 becomes nearly zero regardless of the lens inclination drive voltage of the actuator. In this case, the optical disc 7 may be re-clamped.

Then, the drive voltage is slightly increased, and an envelope amplitude obtained with the increased drive voltage is stored in combination with the drive voltage in the memory at a different address (step S42). This process is performed until the drive voltage reaches the maximum value (steps S43 and S44) and, finally, a drive voltage which maximizes the envelope amplitude is then transmitted to the coma aberration control initialization unit 30. The coma aberration control initialization unit 30 stores V_{offset} in the memory as a reference point for lens inclination drive of the three-axes actuator 16 (step S45) (Optimization of the first radial coma aberration compensating unit).

Then, the pickup moves to the pattern area for compensation of the tangential pickup-coma aberration CoTA (step S5) and, after the drive voltage of the TAN coma aberration compensating-unit 15TAN (first tangential coma aberration compensating unit) is optimized, the drive voltage is stored as V_{TAN} in the memory. Specifically, this process can be performed using a method similar to that performed in the radial direction (step S6). A series of the above steps S1-S6 is the first coma aberration compensating step.

Then, the second coma aberration compensating step is performed. First, the light beam is focused on the deepest layer as the specific layer (step S7) and the drive voltage of the three-axes actuator 16, which functions as the second radial coma aberration compensating unit in this process, is then optimized. The optimized drive voltage is transmitted to the coma aberration control initialization unit 30. The coma aberration control initialization unit 30 stores a value obtained by subtracting the previously stored V_{offset} from the optimized drive voltage in the memory (step S8). Specifically, this process can be performed using a method similar to that of the first coma aberration compensating step.

A series of the above steps S7 and S8 is the second coma aberration compensating step.

When the user has jumped the focusing from the specific layer to a different recording layer (step S9), the three-axes actuator 16 is driven using a voltage value V′_{RAD} obtained by multiplying the previously stored drive voltage value V_{RAD} by a predetermined factor α which is the ratio of the transmitted layer's thickness above the recording layer to which focusing has been jumped, to the transmitted layer's thickness above the specific layer (step S10). Tracking is then performed (step S11) and recording or reproducing is initiated.

In this embodiment, first, the first coma aberration compensating unit is optimized with the beam being focused on the surface of the optical disc (first coma aberration compensating step). The purpose of focusing the light beam on the optical disc surface is to bring the transmitted layer's thickness to zero so that no transmitted-layer-coma aberration occurs. By adjusting the first coma aberration compensating unit in this state, it is possible to cancel the pickup-coma aberration with the off-axis coma aberration alone. However, in this state, it is not possible to compensate a transmitted-layer-coma aberration caused when the user has jumped the focusing to a recording layer in order to record or reproduce information since no transmitted-layer-coma aberration occurs no matter how much the optical axis of the beam is inclined with respect to the normal line to the optical disc in such a state. Therefore, after the first coma aberration compensating unit, the second coma aberration compensating unit is adjusted while monitoring the transmitted-layer-coma aberration with the beam again being focused on the specific layer of the optical disc 7 (second coma aberration compensating step). In this case, when it is taken into consideration that the accuracy of adjustment increases as the transmitted-layer-coma aberration caused by inclination of the beam optical axis with respect to the normal line to the optical disc increases, it is desirable that the transmitted layer's thickness be as high as possible. Therefore, it is preferable that the specific layer be the deepest layer.

At step S10, the optimized drive voltage V′_{RAD} of the three-axes actuator 16 can be obtained at any recording layer simply by applying the predetermined factor α, which is the ratio of transmitted layer's thicknesses, since the first coma aberration compensating step is previously performed, i.e., since the drive voltage V_{offset} for canceling the pickup-coma aberration of the radial direction at the optical disc surface with the off-axis coma aberration has been previously stored as a reference point so that the transmitted-layer-coma aberration is the only coma aberration that should be compensated by the second coma aberration compensating unit. This eliminates the need to optimize the drive voltage of the second coma aberration compensating unit for all recording layers and thus significantly reduces the time required to perform adjustment when the user has loaded an optical disc.

Although, in this embodiment, the second coma aberration compensating step is not performed for the tangential direction since the transmitted-layer-coma aberration of the tangential direction caused by warpage of the optical disc is small compared to that of the radial direction, the same means and method as those of the radial direction may be implemented and performed for the tangential direction in the case where there is also a need to compensate the transmitted-layer-coma aberration of the tangential direction.

Since the pickup-coma aberration is caused by processing or assembly errors of optical parts, there is no need to perform the first coma aberration compensating step each time a disc is loaded once the first coma aberration compensating step is initially performed. However, the pickup-coma aberration may also vary over a long period due to changes of environmental temperature or temporal changes of the optical system of the pickup. Therefore, the first coma aberration compensating step may be performed at regular intervals to maintain the state in which the pickup-coma aberration is compensated for and to achieve reliable recording and reproducing over a long period.

In the case where the frontmost (or uppermost) recording layer of the multi-layer optical disc is sufficiently near the optical disc surface, the first coma aberration compensating step may be performed with the beam being focused on the frontmost recording layer. In this case, it is possible to adjust the amount of coma aberration by monitoring the amplitude of an RF signal or a tracking error signal as described in Japanese Patent Application Publication No. 2004-355759 or Japanese Patent Application Publication No. 2005-196896.

In this embodiment, the ratio of transmitted layer's thicknesses is used as the predetermined factor α. However, in the case where the beam diameter varies depending on the amount of spherical aberration compensation or in the case where a remaining spherical aberration is present, a factor that minimizes the transmitted-layer-coma aberration may be previously obtained through beam tracing or the like and the obtained factor may then be used as the predetermined factor α.

### Embodiment 2

In Embodiment 2, compensation of coma aberration is performed in advance at the stage of assembling a recording and reproducing device at a factory. Here, the coma aberration compensating device shown in FIG. 13 is used to perform compensation of coma aberration.

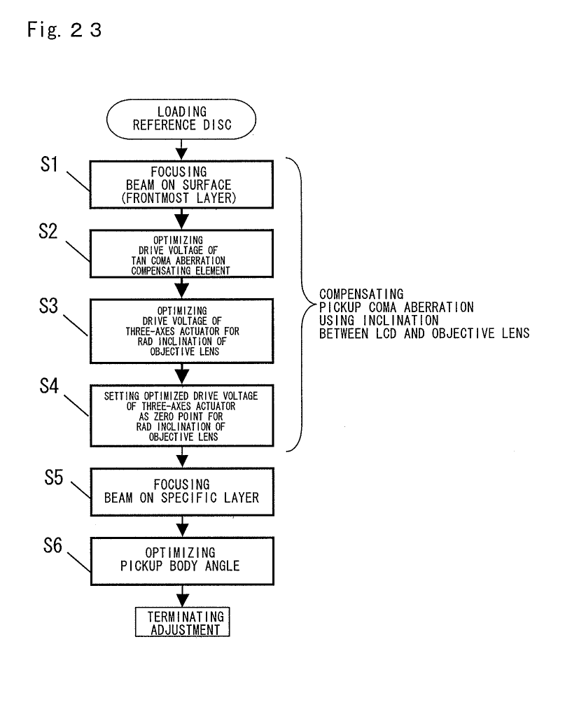

Specifically, a procedure shown in a flow chart of FIG. 23 is performed in the following manner. As described above, when the recording and reproducing device is assembled at the factory, it is possible to directly observe the spot shape at the first coma aberration compensating step and therefore it is possible to use a multi-layer disc without including any periodic pattern for compensation of the pickup-coma aberration formed on the surface of the optical disc, unlike the optical disc 7 of FIG. 5.

First, at the first coma aberration compensating step, a light beam is focused on the surface of a reference optical disc (step S1) and, with the beam being focused on the surface, a drive voltage of the TAN compensation of coma aberration liquid crystal panel 15TAN (first tangential coma aberration compensating unit) is optimized and the optimized drive voltage is stored as V_{TAN} in the memory (step S2). A lens inclination drive voltage of the three-axes actuator 16, which functions as the first radial coma aberration compensating unit in this process, is optimized and the optimized drive voltage is stored as V_{offset} in the memory (steps S3 and S4). Specifically, the drive voltage of the three-axes actuator 16 can be optimized by adjusting the drive voltage such that the shape of the beam spot approaches a perfect circle while directly observing the shape of the beam spot over the reference optical disc.

Subsequently, the second coma aberration compensating step is performed in the following manner. Focusing is jumped to a specific recording layer (preferably, the deepest recording layer) (step S5) and the mounting angle of the pickup 9 is adjusted using the angle adjustment mechanism 9A while again observing the beam spot (step S6). In this embodiment, the angle adjustment mechanism 9A functions as the second radial coma aberration compensating unit.

In the case of a recording and reproducing device that has been adjusted using this adjustment method, if the warpage of a multi-layer optical disc, on or from which the user desires to record or reproduce data, is identical to that of the reference optical disc, the user can perform recording and reproduction on the multi-layer optical disc with the total coma aberration of all layers being nearly zero without performing compensation of coma aberration since the transmitted-layer-coma aberration has already been compensated.

In the case where the warpage of a multi-layer optical disc, on or from which the user desires to record or reproduce data, is different from that of the reference optical disc, a light beam may be focused on a specific layer, when the optical disc has been loaded, and a lens inclination drive voltage of the three-axes actuator 16 may be optimized and V_{RAD} that was stored in the memory at the factory may then be updated using the optimized drive voltage. Since a drive voltage for exactly canceling the pickup-coma aberration has been previously stored as a reference point V_{offset} in the memory at the factory, it is possible to obtain a drive voltage V_{RAD} required to compensate transmitted-layer-coma aberration that is purely caused by the warpage of the multi-layer optical disc without performing the first coma aberration compensating step.

If the first coma aberration compensating step and the second coma aberration compensating step have previously been performed at the factory in the above manner, the user can achieve the same advantages as those of Embodiment 1 without performing the two steps or by performing only the second coma aberration compensating step. The fact that the first coma aberration compensating step need not be performed indicates that the same method can be applied even when recording and reproduction is performed on a multi-layer disc without including any periodic pattern for compensation of the pickup-coma aberration formed on the optical disc surface thereof.

Accordingly, there is no need to optimize the drive voltage of the coma aberration compensating unit for each recording layer, thereby significantly reducing the time required to perform adjustment when the user has loaded an optical disc.

### Embodiment 3

In a procedure according to Embodiment 3, a coma aberration compensating-method is performed at the factory using the coma aberration compensating device shown in FIG. 15. In this embodiment, liquid crystal panels for compensating the coma aberration in two directions (tangential and radial directions) are used as the first coma aberration compensating unit.

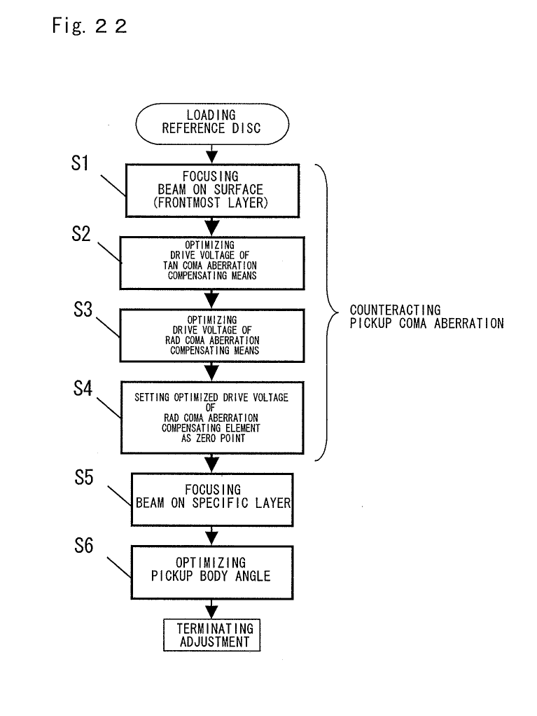

Specifically, a procedure shown in a flow chart of FIG. 22 is performed in the following manner.

First, at the first coma aberration compensating step, a light beam is focused on the surface of a reference optical disc (step S1) and, with the beam being focused on the surface, drive voltages of the compensation of coma aberration liquid crystal panels in two directions are optimized (steps S2 and S3). For example, the drive voltage of each liquid crystal panel can be optimized by adjusting the drive voltage while directly observing the shape of the beam spot over the reference optical disc, similar to Embodiment 2. When the optimal drive voltage of the liquid crystal panel of the radial direction has been obtained, the optimal value is stored as a reference point V_{offset} in the memory (step S4).

Subsequently, at the second coma aberration compensating step, focusing is jumped to a specific layer (preferably, the deepest recording layer) (step S5) and the mounting angle of the pickup 9 is adjusted using the angle adjustment mechanism 9A while again observing the beam spot (step S6). In this embodiment, the angle adjustment mechanism 9A also functions as the second radial coma aberration compensating unit.

In the case of a recording and reproducing device that has been adjusted using this adjustment method, if the warpage of a multi-layer optical disc, on or from which the user desires to record or reproduce data, is identical to that of the reference optical disc, the user can perform recording and reproduction on the multi-layer optical disc with the total coma aberration of all layers being nearly zero without performing optimization of the coma aberration compensating unit since V_{TAN} and V_{RAD} have already been stored in the memory.

In the case where the warpage of a multi-layer optical disc, on or from which the user desires to record or reproduce data, is different from that of the reference optical disc, a light beam may be focused on a specific layer, when the optical disc has been loaded, and the drive voltage of the RAD coma aberration compensating-unit 15RAD may be optimized and V_{RAD} that was stored in the memory at the factory may then be updated using the optimized drive voltage. Since a drive voltage for exactly canceling the pickup-coma aberration has been previously stored as a reference point V_{offset} in the memory at the factory, it is possible to obtain a drive voltage V_{RAD} required to compensate transmitted-layer-coma aberration that is purely caused by the warpage of the optical disc without performing the first coma aberration compensating step.

If the first coma aberration compensating step and the second coma aberration compensating step have previously been performed at the factory in the above manner, the user can achieve the same advantages as those of Embodiment 1 without performing the two steps or by performing only the second coma aberration compensating step. The fact that the first coma aberration compensating step need not be performed indicates that the same method can be applied even when recording and reproduction is performed on a multi-layer disc without including any periodic pattern for compensation of the pickup-coma aberration formed on the optical disc surface thereof.

Accordingly, there is no need to optimize the drive voltage of the coma aberration compensating unit for each recording layer, thereby significantly reducing the time required to perform adjustment when the user has loaded an optical disc.

### Embodiment 4

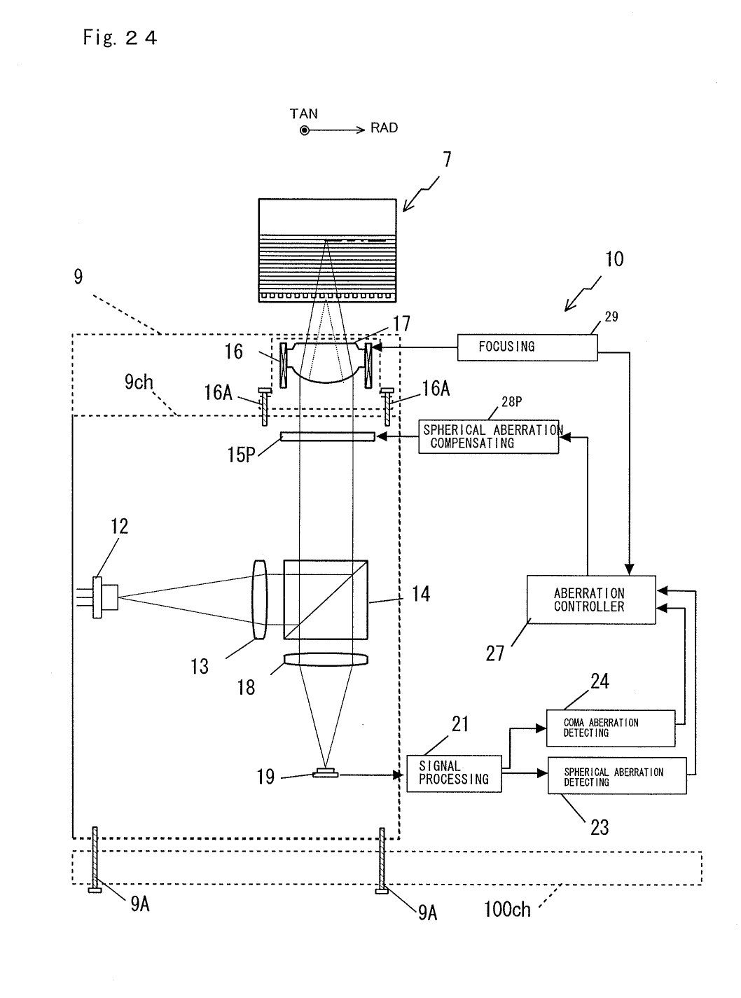

In Embodiment 4, the first and second coma aberration compensating steps are performed at the factory. The optical disc drive device includes a spherical aberration compensation unit 15P and adjustment mechanisms 9A and 16A for changing the mounting angles of the pickup 9 and the actuator 16 as shown in FIG. 24. Specific examples of the inclination adjustment mechanism include so-called screwing described in Patent Literature 2 (Japanese Patent Application Publication No. 10-31826).

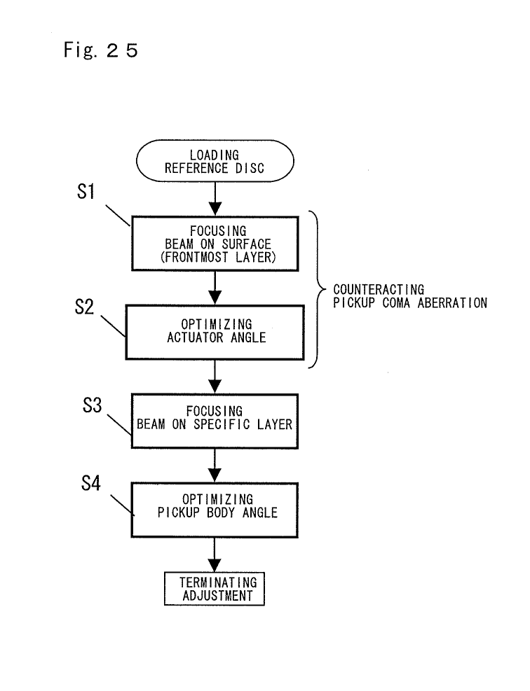

Specifically, a procedure shown in a flow chart of FIG. 25 is performed in the following manner.

First, at the first coma aberration compensating step, a light beam is focused on the surface of a reference optical disc (step S1) and, with the beam being focused on the surface, pickup-coma aberration is compensated (canceled) by adjusting the mounting angle of the actuator 16 (step S2). For example, the mounting angle of the actuator 16 can be adjusted through the angle adjustment mechanism 16A while directly observing the shape of the beam spot over the reference optical disc, similar to Embodiment 2 or 3.

Subsequently, at the second coma aberration compensating step, the spherical aberration compensation unit is driven so as to minimize the spherical aberration when a light beam is being focused on a specific layer and focusing is then jumped to the recording layer (step S3). In this state, the mounting angle of the pickup 9 is adjusted so as to minimize the transmitted-layer-coma aberration (step S4). At this time, it is also possible to adjust the mounting angle while directly observing the shape of the beam spot over the reference optical disc.

In this adjustment method, if the warpage of a multi-layer optical disc, on or from which the user desires to record or reproduce data, is identical to that of the reference optical disc, the user can bring the total coma aberration of all layers to nearly zero without performing optimization of the coma aberration compensating unit since the pickup-coma aberration is canceled with only the off-axis coma aberration and the transmitted-layer-coma aberration is canceled by adjusting the overall angle of the pickup with respect to the reference optical disc.

As described above, in the method for compensating the coma aberration in a pickup of a recording and reproducing device that records or reproduces data on or from an optical disc according to the present invention, a first coma aberration compensating step is performed to compensate pickup-coma aberration in a body of an optical system including an objective lens for emitting a light beam to a multi-layer optical disc and a second coma aberration compensating step is performed to compensate transmitted-layer-coma aberration caused by relative inclination of the optical system with respect to the multi-layer optical disc. For example, as described above, a focusing step is performed to drive the objective lens of the pickup to focus the light beam on a surface proximity of the optical disc and on the plurality of recording layers. Then, at the first coma aberration compensating step, the drive voltage of the first coma aberration compensating unit is optimized and the coma aberration of the body of the optical system is compensated with the light beam being focused on the surface proximity of the optical disc in the optical system. Then, at the second coma aberration compensating step, the drive voltage of the second coma aberration compensating unit is optimized and the coma aberration caused by the relative inclination of the optical system with respect to the optical disc is compensated with the light beam being focused on a recording layer of the optical disc in the optical system.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1-16. (canceled)

17. An optical disc comprising:
a plurality of recording layers on or from which information is recorded or reproduced; and
a pattern region for compensating coma aberration formed on a surface proximity of the optical disc on a front side thereof when viewed in an emitting direction of a light beam from a pickup that records or reproduces information on the recording layers, the pattern region for compensating the coma aberration including periodic patterns formed in the pattern region for detecting the amount of coma aberration in a body of an optical system including the pickup.

18. The optical disc according to claim 17, wherein the pattern region for compensating the coma aberration includes a pattern area for compensation of the radial coma aberration and a pattern area for compensation of the tangential coma aberration.

19. The optical disc according to claim 17, wherein the pattern area for compensation of the radial coma aberration includes single-periodic patterns having a period of λ/(0.75*NA) parallel to a tangential direction when a numerical aperture of an objective lens is “NA” and a wavelength for recording or reproduction is λ.

20. The optical disc according to claim 17, wherein the pattern area for compensation of the tangential coma aberration includes single-periodic patterns having a period of λ/(0.75*NA) parallel to a radial direction when a numerical aperture of an objective lens is “NA” and a wavelength for recording or reproduction is λ.

21. The optical disc according to claim 17, wherein the patterns of the pattern region for compensating the coma aberration are formed in at least one of a concavo-convex structure, a phase-change structure, a reflectance-change structure, and any hybrid structure thereof.

22. The optical disc according to claim 17, wherein an interval between a nearest recording layer and a most distant recording layer among the plurality of recording layers when viewed in an emission direction of the light beam from the pickup is at least 100 μm.
